(19) United States
(12) Patent Application Publication
(10) Pub. No.: US 2011/0055323 A1
(43) Pub. Date: Mar. 3, 2011

(54) IMAGE FORMING SYSTEM, IMAGE FORMING APPARATUS, AND METHOD

(75) Inventors: Takanao Kawai, Osaka (JP); Takashi Araki, Osaka (JP); Yosuke Oka, Osaka (JP); Sun Changsong, Osaka (JP)

(73) Assignee: KYOCERA MITA CORPORATION, Osaka (JP)

(21) Appl. No.: 12/857,284

(22) Filed: Aug. 16, 2010

(30) Foreign Application Priority Data
Aug. 31, 2009 (JP) 2009-199831

(51) Int. Cl. G06F 15/16

(52) U.S. Cl. 709/203

(57) ABSTRACT

In a multifunction peripheral (MFP), a web browser displays a user interface screen on a display of an operation panel and transmits a first command by a predetermined protocol. A web server in the MFP receives the first command using the predetermined protocol. A request processing unit executes a first process corresponding to the first command received from the web server. Meanwhile, in a server device, a server application executes a second process corresponding to the second command transmitted to a web server in the server device from the web browser in the MFP. When using a function or data of the MFP, the server application transmits a third command corresponding to the function or the data to the web server in the MFP from a web client using the predetermined protocol.

### INCORPORATION BY REFERENCE

This application is based upon and claims the benefit of priority from corresponding Japanese Patent Application No. 2009-199831, filed Aug. 31, 2009, the entire contents of which is incorporated herein by reference.

### BACKGROUND

1. Field of the Invention

The present invention relates to an image forming system, an image forming apparatus, and an image forming method using unified internal and external messaging protocols.

2. Description of the Related Art

In some image forming apparatuses including a copier, a printer, and a multifunction peripheral (MFP), applications that perform processes such as printing and copying are operated on a platform. The applications perform the process with internal devices in the image forming apparatus. Further, there is an image forming apparatus that activates an external application added after the image forming apparatus is shipped. The above-described image forming apparatus may use an application installed in the image forming apparatus.

Further, there is an image forming apparatus that causes a server application in a server device connected to a network to execute a process. The above-described image forming apparatus transmits a command to the server device, and causes the server application to execute a process corresponding to the command. However, it is difficult for the server application in the server device to use a function or data that is included in the image forming apparatus.

Further, there is no image forming apparatus that causes both the application in the image forming apparatus and the server application in the server device to execute a process.

### SUMMARY

The present disclosure relates to an image forming system, an image forming apparatus, and a method that cause a server application in a server device to easily use functions or data included in the image forming apparatus, and that cause both an application in the image forming apparatus and the server application to execute a process.

According to one aspect of the present disclosure, an image forming system includes: an image forming apparatus coupled to a network, and a server device coupled to the network. The image forming apparatus may include a display, a web browser configured to display a user interface screen onto the display and transmit first and second commands using a predetermined protocol, a first web server configured to receive the first command using the predetermined protocol, and a request processing unit configured to execute a first process corresponding to the first command received from the first web server. The server device may include a second web server configured to receive the second command from the web browser using the predetermined protocol, a web client, and a server application configured to execute a second process corresponding to the second command received from the second web server.

According to another aspect of the present disclosure, an image forming apparatus coupled to a network may include a communication device configured to communicate with a server device via the network, a display, a web browser configured to display a user interface screen on the display and to transmit first and second commands using a predetermined protocol, a web server configured to receive the first command using the predetermined protocol, and a request processing unit configured to execute a first process corresponding to the first command received by the web server. The web browser is further configured to transmit the second command that executes a server application to the server device through the communication interface.

According to yet another aspect of the present disclosure, an image forming method includes: displaying a user interface screen on a display of an image forming apparatus using a web browser, the image forming apparatus coupled to a network; transmitting a first command using a predetermined protocol from the web browser to a first web server in the image forming apparatus; transmitting the first command using the predetermined protocol from the first web server to a request processing unit in the image forming apparatus; executing a first process corresponding to the first command transmitted from the first web server to the request processing unit; transmitting a second command using the predetermined protocol from the web browser to a second web server in a server device coupled to the network; executing a second process corresponding to the second command transmitted from the second web server to a server application in the server device; and transmitting a third command using the predetermined protocol to the first web server from a web client in the server device.

### BRIEF DESCRIPTION OF THE DRAWINGS

In the accompanying drawings:

FIG. 1 is a block diagram illustrating a configuration of an image forming system according to an embodiment of the present disclosure; and

FIG. 2 is a block diagram illustrating a configuration of a request processing unit of FIG. 1 and cooperation with a server application.

### DETAILED DESCRIPTION

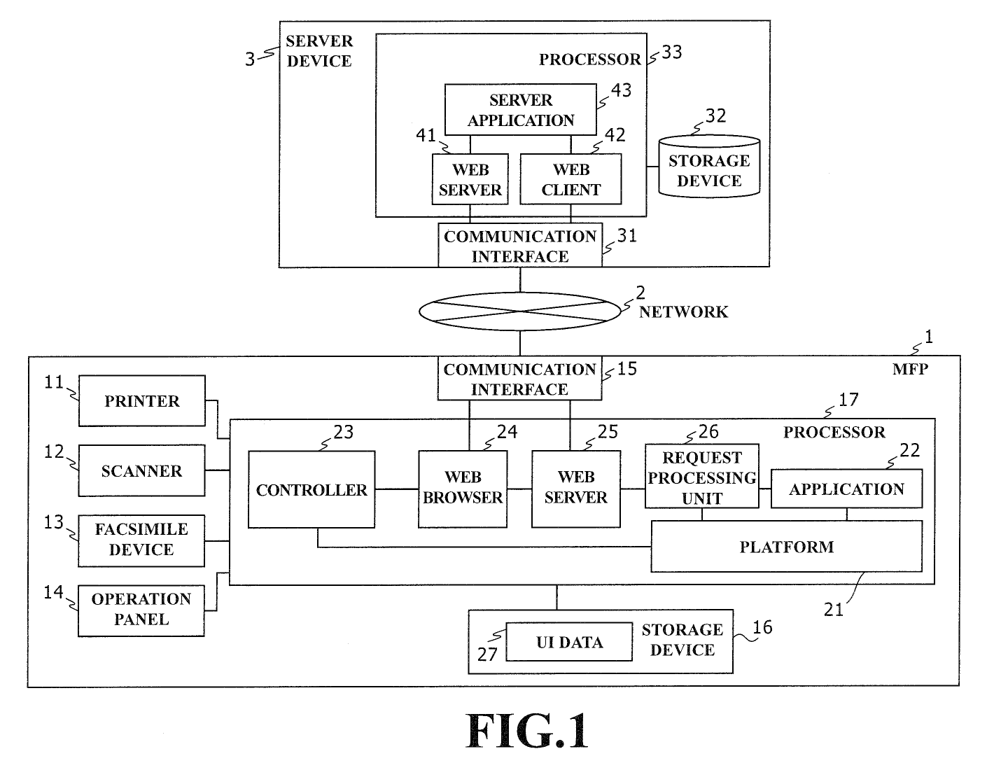

FIG. 1 is a block diagram illustrating a configuration of an image forming system according to an embodiment of the present disclosure. As illustrated in FIG. 1, in the image forming system, a multifunction peripheral (MFP) 1 (example of the image forming apparatus) and a server device 3 are each connected to a network 2. The network 2 may include a local area network (LAN) such as an intranet and a wide area network (WAN) such as the Internet.

The MFP 1, which is an example of the image forming apparatus, includes a printer 11, a scanner 12, a facsimile device 13, an operation panel 14, a communication interface 15, a storage device 16, and a processor 17.

The printer 11 prints document images based on print data. The scanner 12 optically reads document images from documents and generates image data based on the document images. The facsimile device 13 generates facsimile signals from document data and transmits the facsimile signals. The facsimile apparatus 13 also receives facsimile signals and converts the facsimile signals into document data.

The operation panel 14 may include a display that displays various kinds of information to a user and an input device that detects a user operation. The display may include a liquid crystal display (LCD). The input device may include a key switch and/or a touch panel.

The communication interface 15 is connected to the network 2, and communicates with the server device 3 over the network 2. The communication interface 15 may comprise a network interface and a modem.

The storage device 16 stores various programs and various kinds of data. The storage device 16 includes a nonvolatile storage medium such as a hard disk drive or a nonvolatile memory.

In the storage device 16, programs necessary for an operation of the MFP 1 and data used therefor are stored. Further, UI data 27 is stored, that displays a user interface screen such as an operation screen onto the display of the operation panel 14. The UI data 27 may include data described in a markup language and a script described in a script language. For example, the UI data 27 may include hypertext transfer protocol (HTML) data and JavaScript script(s).

The processor 17 includes a central processing unit (CPU), a read only memory (ROM), and a random access memory (RAM). The processor 17 loads programs from the storage device 16 into the RAM, and causes the CPU to execute the programs, to thereby realize various processing units.

After the start of the MFP 1, a program (not illustrated) stored in the storage device 16 is executed by the processor 17. The processor 17 realizes processing units such as an operating system (not illustrated), a platform 21, an application 22, a controller 23, a web browser 24, a web server 25 (example of a first web server), and a request processing unit 26. The web browser 24 and a part of the controller 23 that controls the operation panel 14 are implemented on a first processor board (not illustrated). The platform 21, the application 22, the remaining part of the controller 23, the web server 25, and the request processing unit 26 are implemented on a second processor board (not illustrated). The first processor board and the second processor board include a CPU, a ROM, and a RAM, and load a program from the storage device 16 into the RAM and cause the CPU to execute the program, to thereby realize various processing units. The first processor board and the second processor board may perform data communications with each other through interfaces (not illustrated).

The platform 21 is an execution platform that executes an application. For example, the platform 21 may be a JAVA virtual machine that executes a JAVA application.

The application 22 is realized by executing an application program on the platform 21. The application 22 uses a controller application program interface (API) (not illustrated) to cause the controller 23 to execute an operation specified by a function execution request. The controller 23 causes the printer 11, the scanner 12, the facsimile device 13, and the operation panel 14 to execute the operation specified by the function execution request.

The controller 23 controls the printer 11, the scanner 12, the facsimile apparatus 13, and the operation panel 14 and performs data input/output between them. The controller API provides access to the controller 23. The controller API causes the controller 23 to operate corresponding to an instruction from the application operating on the platform 21 when executing the functions of the printer 11, the scanner 12, the facsimile apparatus 13, and the operation panel 14 and causes the controller 23 to route the data between them.

The web browser 24 has a web client function that communicates with a web server by hypertext transfer protocol (HTTP) and has a screen display function that interprets data in a markup language and displays a screen corresponding to the data. The web browser 24 causes the controller 23 to display the user interface screen onto the display of the operation panel 14. The web browser 24 transmits a received command to the web server 25, and/or the server device 3, by a predetermined protocol. The user interface screen includes an operation unit such as operation buttons, and may be operated by the user for operating the MFP 1 and inputting settings thereto.

The web browser 24 transmits a command corresponding to the script (for example, JavaScript) within the UI data 27 to the web server 25 and/or the web server 41 (example of a second web server) by asynchronous communication with JavaScript Object Notation with Padding (JSONP). In the case of JSONP, if a script element with a URL of the web server 25 and/or the web server 41 being specified in a script tag is processed, the HTTP command is transmitted to the URL. If a response to the HTTP command is returned from the web server 25 and/or the web server 41, a callback function corresponding to the response is executed.

The web server 25 communicates with a web client by HTTP, and receives an HTTP command from the web client. The web server 25 receives a command from the web browser 24 by the predetermined protocol. The web server 25 also receives a command transmitted from a server application 43 in the server device 3 by the predetermined protocol through the communication interface 15.

The request processing unit 26 is realized by executing a program on the platform 21, and functions to execute processes corresponding to commands received at the web server 25. The request processing unit 26 calls an API corresponding to the command, and may execute a process using the functions of the application 22 and the controller 23.

The server device 3 includes a communication interface 31, a storage device 32, and a processor 33.

The communication interface 31 is connected to the network 2, and communicates with the MFP 1 via the network 2. The communication interface 31 may comprise a network interface and a modem.

The storage device 32 stores various programs and various kinds of data. The storage device 32 includes a nonvolatile storage medium such as a hard disk drive and/or a nonvolatile memory.

The processor 33 includes a CPU, a ROM, and a RAM. The processor 33 loads programs from the storage device 32 into the RAM, and causes the CPU to execute the programs, to thereby realize various processing units.

After the start of the server device 3, a program (not illustrated) stored in the storage device 32 is executed by the processor 33. The processor 33 realizes processing units such as an operating system (not illustrated), the web server 41, a web client 42, and the server application 43.

The web server 41 receives commands from the web browser 24 of MFP 1 via a protocol such as HTTP. Similarly, the web client 42 communicates with the web server 25 in the MFP 1 via a protocol such as HTTP.

The server application 43 executes processes corresponding to commands received from the web server 41. When using a function of the MFP 1, the server application 43 transmits a command corresponding to the function to the web server 25 from the web client 42 via a protocol (for example, HTTP). The server application 43 may then transmit a command to the web server 25 asynchronously using JSONP.

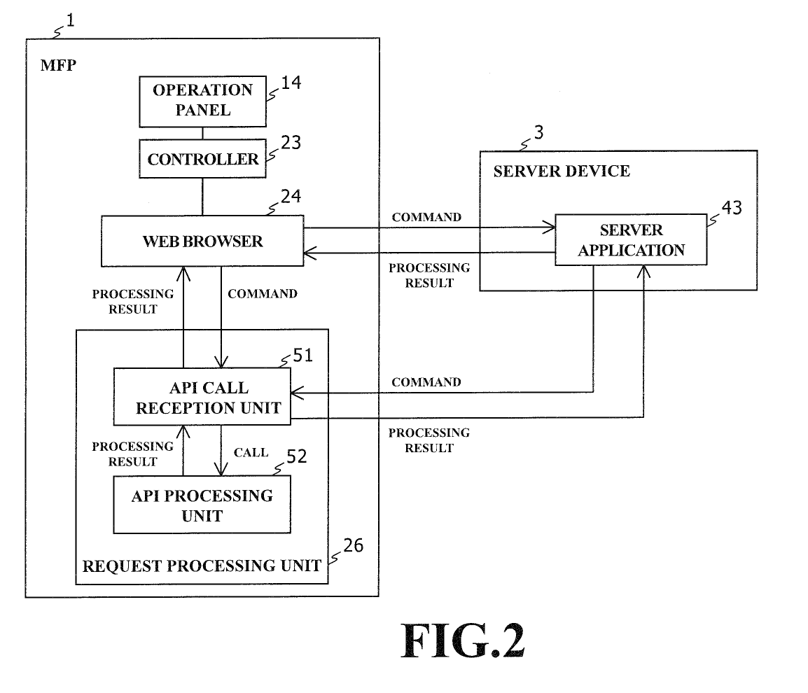

FIG. 2 is a block diagram illustrating a configuration of the request processing unit 26 of FIG. 1 and communications between the server application 43. The devices and the processing units, such as communication interfaces 15 and 31, which exist halfway through a communication path, are omitted in the illustration of FIG. 2.

As illustrated in FIG. 2, the request processing unit 26 includes an API call reception unit 51 (example of a call conversion unit) and an API processing unit 52 (example of an application program interface). The API call reception unit 51 converts commands received from the web server 25 into a call of the API corresponding to the command. The API call reception unit 51 may be, for example, a Java servlet.

The API processing unit 52 is an API that executes a process using the functions of the MFP 1. When the API is called, a program corresponding to the API is executed in the controller 23, the application 22, and the platform 21, and the process specified by the command is executed.

Next, description is made of an operation of the MFP 1.

With reference to FIG. 1, the description is made of (A) a case of using the application 22 in the MFP 1 and (B) a case of using the server application 43 in the server device 3.

(A) Case of using the application 22 in the MFP 1.

The web browser 24 reads the UI data 27, and causes the controller 23 to display the user interface screen corresponding to the UI data 27 onto the display of the operation panel 14.

On the user interface screen, if the user performs an operation for executing printing via a selection on the input device of the operation panel 14, the web browser 24 transmits the command corresponding to the operation in accordance with the executed JavaScript to the web server 25. It should be noted that, data used for the process (print setting data in a case of executing printing) may be included in the command, or may be transmitted in association with the command. For example, the command is set as an HTTP request including a URL of a servlet. In that case, the data used for the process is included in the command as a query string.

Responsive to receiving the command, the web server 25 transmits the command to the API call reception unit 51. The API call reception unit 51 calls the API corresponding to the command. For example, in the case of executing printing, the API of the application 22 for printing is called, and the application 22 for printing is executed. Then, the controller 23 causes the printer 11 to execute the printing.

When the process specified by the command is completed, the API call reception unit 51 acquires a processing result (for example, “printing completion” or “error” in the case of executing printing) as a return value in response to the API call. The API call reception unit 51 transmits the processing result to the web browser 24 from the web server 25 as a response to the command.

When receiving the response (that is, the processing result), the web browser 24 transitions the user interface screen or partially changes the display on the user interface screen corresponding to the processing result.

Accordingly, the process for a case of using the application 22 within the MFP 1 is performed.

(B) Case of using the server application 43 in the server device 3.

The web browser 24 reads the UI data 27, and causes the controller 23 to display the user interface screen on the display of the operation panel 14 corresponding to the UI data 27.

On the user interface screen, if the user performs an operation for executing, for example, user authentication through the input device of the operation panel 14, the web browser 24 transmits the command corresponding to the operation in accordance with the executed JavaScript to the web server 41 in the server device 3 via the network 2. It should be noted that, data used in the process (for example, user authentication setting data in a case of executing user authentication) may be included in the command, or may be transmitted in association with the command.

Responsive to receiving the command, the web server 41 calls the server application 43 corresponding to the command. For example, in the case of executing user authentication, the server application 43 for user authentication is called. The server application 43 for user authentication executes a user authentication process to decide whether or not the user operating the MFP 1 is an authorized user by referring to user identification information on registered users stored in the storage device 32.

If execution of the function of the MFP 1 or acquisition of the data included in the MFP 1 becomes necessary during execution of the server application 43, the server application 43 transmits the command corresponding to a request therefor to the web server 25 in the MFP 1 from the web client 42. In the MFP 1, when the web server 25 receives the command, the request processing unit 26 calls the API corresponding to the command, and causes the controller 23 or the application 22 to execute the process specified by the command. Then, the web server 25 acquires the processing result from the request processing unit 26, and transmits the processing result to the server application 43. When receiving the processing result, the server application 43 uses the processing result to continue the process specified by the command received from the web browser 24. It should be noted that, depending upon the type of command from the server application 43, the command may not be responded to.

For example, in the case of executing user authentication, the server application 43 causes an IC card reader (not illustrated), which is connected to the MFP 1, to transmit a command for acquiring the user identification information from an IC card presented by the user, to the web server 25 of the MFP 1. In the MFP 1, when the web server 25 receives the command, the request processing unit 26 calls the API corresponding to the command, and causes the controller 23 to execute reading of the user identification information through the IC card reader. The controller 23 causes the IC card reader to read the user identification information. The request processing unit 26 acquires the user identification information as the return value in response to the API call. The web server 25 acquires the processing result (that is, user identification information) from the request processing unit 26, and transmits the processing result to the server application 43. When the server application 43 receives the user identification information as the response to the command, the server application executes the user authentication process using the user identification information.

When the process specified by the command is completed, the server application 43 transmits the processing result (for example, an authentication success or an authentication failure in the case of executing user authentication) to the web browser 24 from the web server 41 via the network 2 as a response to the command.

When receiving the response (that is, the processing result), the web browser 24 transitions the user interface screen or partially changes the display on the user interface screen corresponding to the processing result.

Accordingly, the process for a case of using the server application 43 in the server device 3 is performed.

It should be noted that, the command of a processing request transmitted from the server application 43 to the MFP 1 is not limited to the above-described example of the IC card, and the commands of various other processing requests may be used.

For example, the processing requests transmitted from the server application 43 to the MFP 1 may include:

(1) hardware control for the devices existing in the MFP 1 or the devices connected to the MFP 1;

(2) a job operation in the MFP 1;

(3) creation, deletion, changing, and referencing of user information (user identification information and user attribute information) and group information;

(4) acquisition of setting values and attribute values (such as serial number of the MFP 1, MAC address of the communication interface 15, host name, and IP address) of the equipment existing in the MFP 1; and

(5) acquisition of a system log of the MFP 1.

Examples of hardware control include causing a light emitting diode (LED) within the operation panel 14 to be lit and unlit or turning on and off of a buzzer (not illustrated). The controller 23 is called from the request processing unit 26, and the controller 23 controls the LED or the buzzer.

Examples of job operation include job canceling, acquisition of a state of a job, and execution of a transmission job. The application 22 is called from the request processing unit 26, and the application 22 executes the process. An example of the transmission job is file transmission, that is, transmission of a data file for a scan image using the predetermined protocol.

In a case where the MFP 1 is provided with a database including user information and group information in advance, the creation, deletion, changing, and referencing of the user information and the group information may be requested by the server application 43 for user management and group management.

The acquisition of a system log may be requested by the server application 43 for storing log data on the MFP 1 in the server device 3. The system log includes an execution history of the platform 21 and execution histories of the various applications 22.

According to the above-described embodiment, in the MFP 1, the web browser 24 displays the user interface screen on the display of the operation panel 14 and transmits the command using a predetermined protocol, the web server 25 receives the command transmitted using the predetermined protocol, and the request processing unit 26 executes a process corresponding to the command received by the web server 25. Meanwhile, in the server device 3, the web server 41 receives the command from the web browser 24, and the server application 43 executes a process corresponding to the command received from the web server 41, and when requiring a function or data from the MFP 1, transmits a command corresponding to the function or data to the web server 25 from the web client 42 by the predetermined protocol.

Accordingly, the web server 25 in the MFP 1 receives not only the command from the web browser 24 in the MFP 1 but also the command from the server device 3, and hence in a case where the MFP 1 and the server device 3 cooperate with each other, the server application 43 in the server device 3 can easily use functions or data included in the MFP 1.

Further, the commands from the web browser 24 and the commands from the server device 3 have a common format, so that a separate processing system that processes the commands from the server device 3 does not need to be provided.

The present disclosure includes various other embodiments. For example, other designs can be used in which the above-described components are each performed.

In the system illustrated in FIG. 1, while only one MFP 1 is illustrated, a plurality of MFPs may be connected to the network 2, and each may perform the same or a different operation as the above-described MFP 1.

In the system illustrated in FIG. 1, while only one application 22 is illustrated, a plurality of applications may operate on the platform 21.

In the system illustrated in FIG. 1, while only one server application 43 is illustrated, a plurality of server applications may operate on the server device 3.

According to the above-described embodiment, JSONP is used for asynchronous communications between the MFP 1 and the server device 3, but instead of JSONP, XMLHttpRequest may be used.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. An image forming system, comprising:
an image forming apparatus coupled to a network; and
a server device coupled to the network,
wherein the image forming apparatus comprises:
a display;
a web browser configured to display a user interface screen on the display and transmit first and second commands using a predetermined protocol;
a first web server configured to receive the first command using the predetermined protocol; and
a request processing unit configured to execute a first process corresponding to the first command received from the first web server; and
wherein the server device comprises:
a second web server configured to receive the second command from the web browser using the predetermined protocol;
a web client; and
a server application configured to execute a second process corresponding to the second command received from the second web server.

2. The image forming system according to claim 1, wherein the server application is further configured to transmit a third command to the first web server from the web client using the predetermined protocol.

3. An image forming apparatus coupled to a network, comprising:
a communication interface configured to communicate with a server device via the network;
a display;
a web browser configured to display a user interface screen on the display and to transmit first and second commands using a predetermined protocol;
a web server configured to receive the first command using the predetermined protocol; and
a request processing unit configured to execute a first process corresponding to the first command received by the web server,
wherein the web browser is further configured to transmit the second command that executes a server application to the server device through the communication interface.

4. The image forming apparatus according to claim 3, wherein the web server is further configured to receive a third command transmitted from the server application executed on the server device through the communication interface using the predetermined protocol.

5. The image forming apparatus according to claim 4, wherein the web server receives the first command from within the image forming apparatus and the third command from the server device, the server device being external to the image forming apparatus.

6. The image forming apparatus according to claim 3, further comprising a platform configured to execute an application,
wherein the application comprises an application program executed on the platform.

7. The image forming apparatus according to claim 6, further comprising a controller configured to operate responsive to instructions from the server application and responsive to instructions from the application.

8. The image forming apparatus according to claim 6, wherein the platform comprises a Java virtual machine and the application comprises a Java application.

9. The image forming apparatus according to claim 3, wherein the predetermined protocol is HTTP.

10. The image forming apparatus according to claim 5, wherein the first command transmitted from the inside of the image forming apparatus is the same as the third command transmitted from the server device.

11. The image forming apparatus according to claim 10, wherein the command is an HTTP request including a URL of a servlet.

12. An image forming apparatus coupled to a network, comprising:
a communication interface configured to communicate with a server device via the network;
a display;
a web browser configured to display a user interface screen on the display and to transmit first and second commands using a predetermined protocol;
a web server configured to receive the first command using the predetermined protocol; and
a request processing unit configured to execute a first process corresponding to the first command received from the web server,
wherein the web browser is further configured to transmit the second command to the server device through the communication interface to execute a server application, and to transmit the first command that executes an application in the image forming apparatus to the web server; and
wherein the web server is further configured to receive a third command transmitted from the server application in the server device through the communication interface, and to receive the first command transmitted from the web browser.

13. The image forming apparatus according to claim 12, further comprising a storage device configured to store UI data that displays the user interface screen on the display,
wherein the UI data includes data described in a markup language and a script described in a script language; and
wherein the web browser is further configured to interpret and execute the UI data and to transmit the first command responsive to the execution of the script.

14. The image forming apparatus according to claim 13, wherein:
the markup language is HTML; and
the web browser causes the display to display the user interface screen corresponding to the HTML UI data.

15. The image forming apparatus according to claim 13, wherein the web browser is further configured to transmit the second command via an asynchronous communication.

16. The image forming apparatus according to claim 15, wherein:
the script language is JavaScript; and
the second command is transmitted using JavaScript Object Notation with Padding (JSONP).

17. The image forming apparatus according to claim 15, wherein the web server receives the third command transmitted from the server device via an asynchronous communication.

18. The image forming apparatus according to claim 17, wherein the third command transmitted from the server device is received using JavaScript Object Notation with Padding (JSONP).

19. The image forming apparatus according to claim 12, wherein the request processing unit comprises:
an application program interface configured to execute the first process using a function of the image forming apparatus; and
a call conversion unit configured to convert the first command received by the web server into a call of the application program interface corresponding to the first command.

20. The image forming apparatus according to claim 19, wherein the call conversion unit is a JAVA Servlet.

21. An image forming method, comprising:
displaying a user interface screen on a display of an image forming apparatus using a web browser, the image forming apparatus coupled to a network;
transmitting a first command using a predetermined protocol from the web browser to a first web server in the image forming apparatus;
transmitting the first command using the predetermined protocol from the first web server to a request processing unit in the image forming apparatus;
executing a first process corresponding to the first command transmitted from the first web server to the request processing unit;
transmitting a second command using the predetermined protocol from the web browser to a second web server in a server device coupled to the network;
executing a second process corresponding to the second command transmitted from the second web server to a server application in the server device; and
transmitting a third command using the predetermined protocol to the first web server from a web client in the server device.
